(19) United States
(12) Patent Application Publication
(10) Pub. No.: US 2024/0149979 A1
(43) Pub. Date: May 9, 2024

(54) HYDROFOIL

(71) Applicant: Electro Nautic Pty Ltd, Jandakot (AU)

(72) Inventors: Michael Andrewartha, Jadakot (AU); Joshua Portlock, Jandakot (AU)

(21) Appl. No.: 18/550,384

(22) PCT Filed: Mar. 15, 2022
(86) PCT No.: PCT/AU2022/050217

§ 371 Date: Sep. 13, 2023

(30) Foreign Application Priority Data
Mar. 16, 2021 (AU) AU2021900752
Jul. 26, 2021 (AU) AU2021104570

(51) Int. Cl. B63B 1/28; B63B 1/24; B63B 39/06; B63H 21/17; B63H 21/21

(52) U.S. Cl. CPC B63B 1/286; B63B 1/242; B63B 1/246; B63B 1/248; B63B 39/06; B63H 21/17; B63H 21/21

(57) ABSTRACT

A hydrofoil may include a starboard support structure and a port support structure. Each structure may be hollow and extend longitudinally in a fore-aft direction and being parallel to one another. The hydrofoil may include an anhedral wing having ends at either side of the wing. The ends may be connected to the starboard and port support structures. The hydrofoil may include a starboard electric propulsor mounted to the starboard support structure and a port electric propulsor mounted to the port support structure. The hydrofoil may also optionally include a front wing having ends at either side of the front wing. The ends of the front may be connected to the starboard and port support structures.

### CROSS REFERENCE

This application is a U.S. National Phase Application of International Application No. PCT/AU2022/050217 filed on 15 Mar. 2022, which in turn claims priority to AU2021900752 filed 16 Mar. 2021 and AU2021104570 filed 26 Jul. 2021, the disclosures of each of which are hereby incorporated by reference herein in their entireties.

### TECHNICAL FIELD

This disclosure relates generally to hydrofoils, and in some embodiments hydrofoils that are used on personal watercraft.

### BACKGROUND

Watercraft need to move from being powered by non-renewable to renewable power sources to help reduce or eliminate the production of greenhouse gases. One way to provide renewable-powered propulsion is to use electric propulsion to avoid any pollution of the water, as well as any emission of CO₂.

The amount of energy needed to move a typical boat or watercraft is large due to waves generated at the water-air interface and frictional drag on the hull surfaces. This power requirement limits the use of electric propulsion to very low speed, or to the use of expensive electric propulsion systems that require significant battery power to achieve high vessel speeds.

A way to significantly reduce the energy needed for a propulsion system for a watercraft is to use hydrofoils which lift the craft above the water thereby minimising drag. Some examples of hydrofoils include surface piercing foils, ladder foils, or inverted T foils. Surface piercing foils and ladder foils configurations are passively stable, but they don't allow watercraft to perform sharply banked turns as the watercraft cannot bank, and they cannot smooth out choppy waves.

T-foils have manufacturing and durability issues, given the significant amount of load that passes through the T intersection in use. Therefore, a “U” shaped mast configuration whereby wings are mounted to the hull using vertical masts on either side of the wings, avoids these issues with T-foils. However, manoeuvrability and controllability of U-shaped foils limits their use.

It is to be understood that, if any prior publication is referred to herein, such reference does not constitute an admission that the publication forms part of the common general knowledge in the art, in Australia, or any other country.

### SUMMARY

An embodiment provides a hydrofoil comprising:
i. a starboard support structure and a port support structure, each structure being hollow and extending longitudinally in a fore-aft direction and being parallel to one another;
ii. an anhedral wing having ends connected to the starboard support structure and port support structure; and
iii. a starboard electric propulsor mounted to the starboard support structure and a port electric propulsor mounted to the port support structure.

Throughout this disclosure, the term “hydrofoil” means a hydrofoil structure that can include one or more wings (e.g. hydrofoil wings) and any associated support structure such as that used to support a wing and to mount the hydrofoil to a watercraft. Accordingly, throughout this disclosure the term “hydrofoil” is not to be interpreted as being limited to a hydrofoil wing unless context makes it clear otherwise.

The anhedral wing may have at a trailing edge a starboard control flap and a port control flap, each control flap being rotatable about a rotation axis. A hydrofoil may further comprise an electronically controlled actuator connected to each control flap. Each of the electronically controlled actuators may be located in the starboard support structure or the port support structure. Each electronically controlled actuator may have a shaft that is rotatable about an actuator rotation axis. Each electronically controlled actuator may be directly connected to a respective control flap such that the rotation axis of the control flap and the rotation axis of the shaft are aligned. An angle of the anhedral wing may range from about 5° to about 25°. The angle of the anhedral wing may range from about 10° to about 20°. The starboard support structure and the port support structure may each be dimensioned relative the anhedral wing to act as wing caps.

An embodiment provides a hydrofoil comprising:
i. a starboard support structure and a port support structure, each structure being hollow and extending longitudinally in a fore-aft direction and being parallel to one another;
ii. a front wing having ends connected to the starboard and port support structures;
iii. a rear anhedral wing having ends connected to the starboard and port support structures; and
iv. a starboard electric propulsor mounted to the starboard support structure and a port electric propulsor mounted to the port support structure.

Throughout this disclosure, the term “watercraft” is to be interpreted broadly to include within its scope any craft that is used on water, including a single-hulled vessel or boat, a multi-hulled vessel or boat, power boards, yachts, jet skis, paddleboards, and surfboards of any size.

The front wing and rear wing may each have at a trailing edge a starboard control flap and a port control flap. A trailing edge of the front wing may have a starboard control flap and a port control flap. A trailing edge of the rear wing may have a starboard control flap and a port control flap. A trailing edge of the anhedral wing may have a starboard control flap and a port control flap. Each control flap may be rotatable about a rotation axis. The hydrofoil may further comprise an electronically controlled actuator connected to each control flap. Each of the electronically controlled actuators may be located in the starboard support structure or the port support structure. Each electronically controlled actuator may have a shaft that is rotatable about an actuator rotation axis. Each electronically controlled actuator may be directly connected to a respective control flap such that the rotation axis of the control flap and the rotation axis of the shaft is aligned.

The hydrofoil may further comprise a starboard speed controller located in the starboard support structure and a port speed controller located in the port support structure. The starboard speed controller may be in electrical communication with the starboard electric propulsor and the port speed controller may be in electrical communication with the port electric propulsor. The rear anhedral wing may have a starboard portion and a port portion. The starboard portion and port portion may be connected by a connector. An apex of the rear anhedral wing may be located on a plane that is above a plane of the front hydrofoil wing. An anhedral angle of the rear anhedral wing may range from about 5° to about 25°. The angle of the rear anhedral wing may range from about 10° to about 20°.

The hydrofoil may further comprise a starboard auxiliary front hydrofoil wing extending laterally out from the starboard support structure and a port auxiliary front hydrofoil wing extending laterally from the port support structure. The starboard auxiliary front hydrofoil wing and the port auxiliary front hydrofoil wing may share a common longitudinal position with the front wing. In use, the front hydrofoil wing may provide greater lift than the rear hydrofoil wing. The starboard support structure and port support structure may be dimensioned relative the front wing and rear anhedral wing to act as wing caps. A ratio of a vertical thickness of the starboard support structure and port support structure to a thickness of the front hydrofoil wing and/or (rear) anhedral wing may be at least 2:1. The ratio may be 2.5:1, 3:1, 4:1, 5:1, or >5:1.

The hydrofoil may further comprise a mounting structure for mounting the hydrofoil to a watercraft. The mounting structure may include one or more masts. The one or more masts may include a starboard mast extending transversely from the starboard support structure and a port mast extending transversely from the port support structure. The starboard and port masts may extend transversely in a direction towards an aft of the support structures.

The starboard electric propulsor may be mounted at a rear of the starboard support structure and a port electric propulsor may be mounted at a rear of the port support structure. At least a portion of the starboard electric propulsor may be mounted within the starboard support structure and at least a portion of the port electric propulsor may be mounted within the port support structure. Each propulsor may be provided with a duct that surrounds a propeller. Each duct may further include a fin on a bottom side of the propulsor that extends from the duct in a fore direction. The starboard support structure and/or port support structure may be provided with a nose cone. The nose cone may be fitted with one or more sensors. The nose cone may be replaceable.

An embodiment provides a watercraft fitted with the hydrofoil as set forth above.

An embodiment provides a method of operating a hydrofoil connected to a watercraft, the hydrofoil comprising: a front wing having a front starboard control flap and a port control flap; a rear anhedral wing having a rear starboard control flap and a rear port control flap; a starboard electric propulsor and port electric propulsor, the method comprising:
i. activating the starboard electric propulsor and/or the port electric propulsor to generate a flow of water over the front and rear anhedral wing; and
ii. actuating the front starboard control flap and/or the port control flap from the front wing to generate lift.

The method may further comprise actuating the front starboard control flap and front port control flap on the front wing to control lift and altitude from the front wing. The method may further comprise actuating the rear starboard control flap and rear port control flap on the rear anhedral wing to control lift and altitude from the rear wing. The method may further comprise adjusting the front starboard control flap and front port control flap on the front wing differentially to the rear starboard control flap and rear port control flap on the rear anhedral wing to control a pitch of the watercraft. The method may further comprise actuating the front starboard control flap on the front and the rear starboard control flap on the rear anhedral wing differently to the front port control flap on the front and the rear port control flap on the rear anhedral wing to control a roll of the watercraft.

The method may further comprise differentially actuating the rear starboard control flap and the rear port control flap on the rear wing to control a yaw and/or roll of the watercraft. The method may further comprise applying a differential thrust to the starboard and port electric propulsors to control a yaw of the watercraft. The method may further comprise controlling the starboard electric propulsor and the port electric propulsor to increase the flow of water over the front wing and the rear anhedral wing, and actuating the front starboard control flap, the front port control flap, the rear starboard control flap, and/or the rear port control flap as a function of watercraft speed to adjust lift generated at the front wing and/or the rear anhedral wing. The hydrofoil used in the method may be that as set forth above.

An embodiment provides a watercraft comprising a hydrofoil that is operated using the method as set forth above.

These embodiments are merely illustrative aspects of the innumerable aspects associated with the present disclosure and should not be deemed as limiting in any manner. These and other embodiment, aspects, features and advantages of the present disclosure will become apparent from the following detailed description when taken in conjunction with the referenced figures.

### BRIEF DESCRIPTION OF FIGURES

Embodiments will now be described by way of example only with reference to the accompanying non-limiting Figures, in which:

FIG. 1 shows a perspective view of an embodiment of a hydrofoil;

FIG. 2 shows a top view of the embodiment shown in FIG. 1;

FIG. 3 shows a side view of the embodiment shown in FIG. 1;

FIG. 4 shows a front view of the embodiment shown in FIG. 1;

FIG. 5 shows a perspective view of an embodiment of a propulsor;

FIG. 6 shows a side view of an embodiment of a propulsor;

FIG. 7 shows a cross-sectional view along line A-A in FIG. 1;

FIG. 8 shows a cross-sectional view along line B-B in FIG. 1;

FIG. 9 shows a perspective view of another embodiment of a hydrofoil;

FIG. 10 shows a perspective view of another embodiment of a hydrofoil; and

FIG. 11 shows an embodiment of a control flow diagram.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

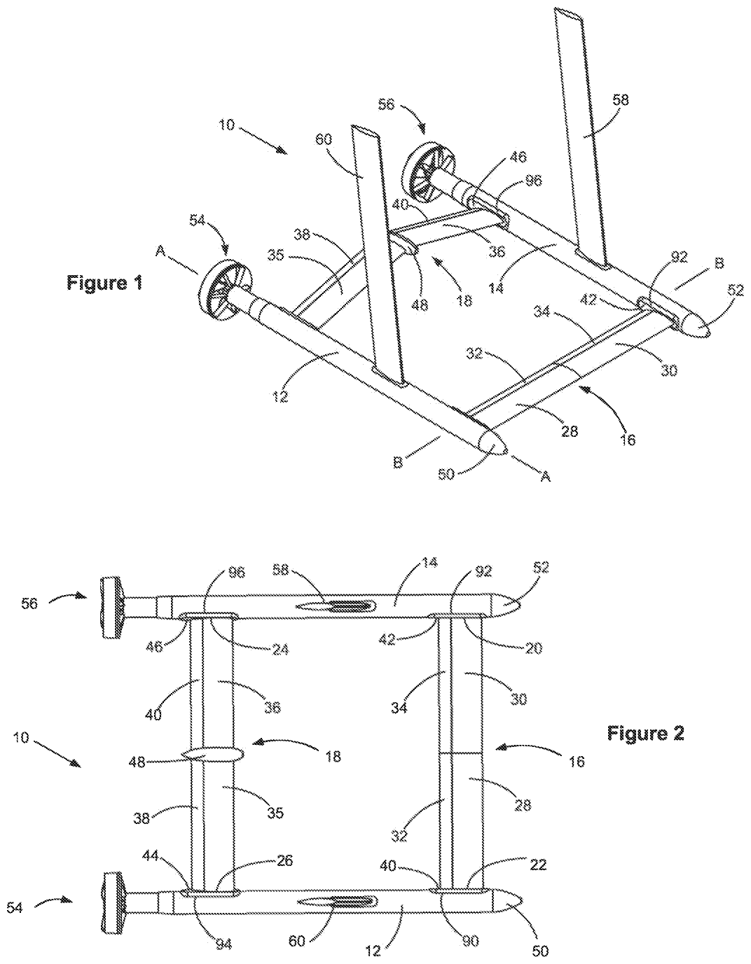

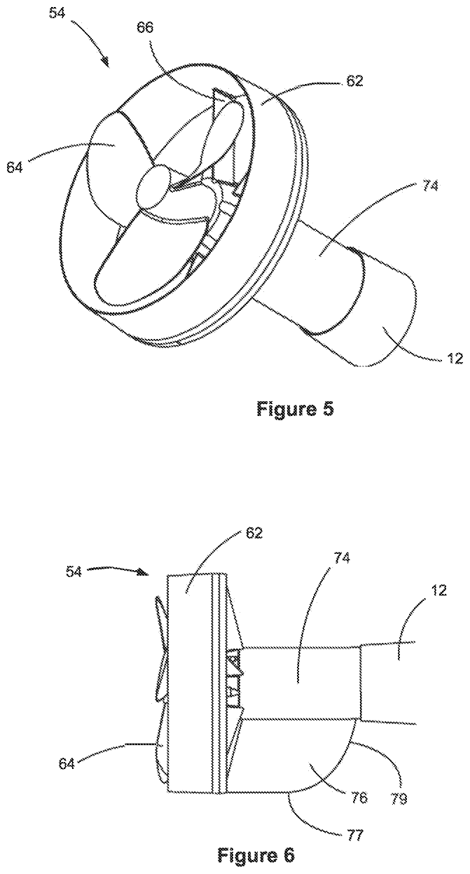

Disclosed is a hydrofoil. An embodiment of a hydrofoil 10 is shown in FIG. 1 to FIG. 8. The hydrofoil 10 has a starboard support structure in the form of starboard tube or nacelle 12, and a port support structure in the form of port tube or nacelle 14. Each nacelle 12 and 14 extends longitudinally in a fore-aft direction. In an embodiment, a length of each nacelle 12 and 14 ranges from about 600 mm to about 2500 mm. In an embodiment, a length of each nacelle 12 and 14 is equal to or greater than 600 mm. In an embodiment, a length of each nacelle 12 and 14 is equal to or less than 2500 mm. Typically, the nacelles 12 and 14 have the same length.

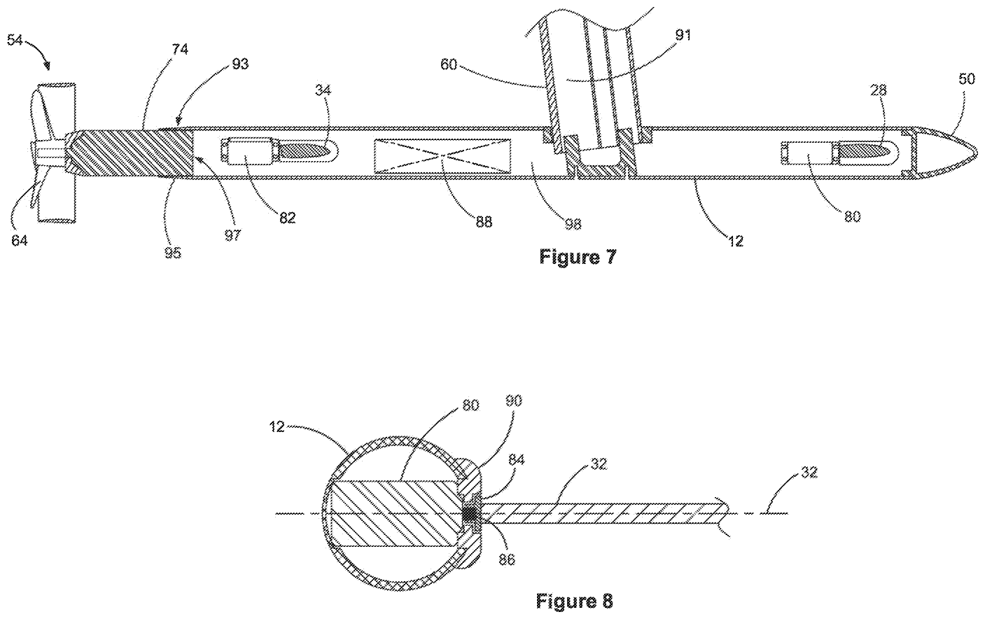

The nacelles 12 and 14 are parallel to one another. In combination, the nacelles 12 and 14 act as a frame, or frame components, to which other components are attached to. In an embodiment, the nacelles are hollow and define an interior 98, as best seen in FIG. 7. The nacelles 12 and 14 shown in the Figures have a circular cross-section where the nacelles 12 and 14 have a constant radius. However, in an embodiment, the nacelles 12 and 14 have a non-uniform radius. For example, a cross-section of the nacelles 12 and 14 may be oval or D-shaped.

In an embodiment, a diameter of the nacelles 12 and 14 ranges from about 50 mm to about 150 mm. In an embodiment, a diameter of the nacelles 12 and 14 ranges from about 50 mm to about 100 mm. In an embodiment, a diameter of the nacelles 12 and 14 ranges from about 100 mm to about 150 mm. In an embodiment, a diameter of the nacelles 12 and 14 is equal to or greater than 50 mm. In an embodiment, a diameter of the nacelles 12 and 14 is equal to or less than 150 mm. In an embodiment, a diameter of the nacelles 12 and 14 is 50 mm. In an embodiment, a diameter of the nacelles 12 and 14 is 60 mm. In an embodiment, a diameter of the nacelles 12 and 14 is 70 mm. In an embodiment, a diameter of the nacelles 12 and 14 is 80 mm. In an embodiment, a diameter of the nacelles 12 and 14 is 90 mm. In an embodiment, a diameter of the nacelles 12 and 14 is 100 mm. In an embodiment, a diameter of the nacelles 12 and 14 is 110 mm. In an embodiment, a diameter of the nacelles 12 and 14 is 120 mm. In an embodiment, a diameter of the nacelles 12 and 14 is 130 mm. In an embodiment, a diameter of the nacelles 12 and 14 is 140 mm. In an embodiment, a diameter of the nacelles 12 and 14 is 150 mm.

The hydrofoil 10 has a front wing 16 and rear wing 18. A profile of the wings 16 and 18 may be determined by the application of the hydrofoil e.g. optimised for watercraft range or optimised for watercraft speed. In an embodiment, a [thickness]:[cord] ratio may range from about 5% to about 20%. In an embodiment, the front wing 16 and/or rear wing 18 has a chord of about 120 mm to about 250 mm. In an embodiment, the front wing 16 and/or rear wing 18 has a span of about 500 mm to about 3000 mm. A take-off weight of the hydrofoil is dependent upon the profile of the wings 16 and/or 18. In an embodiment, a take-off-weight of the hydrofoil 10 ranges from about 150 kg to about 2,500 kg.

The front wing 16 has a starboard side or end 22 that is connected to the starboard nacelle 12 and a port side or end 20 that is connected to the port nacelle 14. The front wing 16 is attached to the nacelles 12 and 14 towards a front (or bow) of the nacelles 12 and 14. The rear wing 18 has a starboard side or end 26 that is connected to the starboard nacelle 12 and a port side or end 24 that is connected to the port nacelle 14. The rear wing 18 is attached to the nacelles 12 and 14 towards a rear (or aft or stern) of the nacelles 12 and 14. The terms “front” and “rear” are used relatively and do not limit the wings 16 and 18 to any specific location on the nacelles other than one is more forward or fore than the other relative the longitudinal direction of the nacelles 12 and 14. In an embodiment, the wings 16 and/or 18 are formed from extruded aluminium. In an embodiment, the wings 16 and/or 18 are formed from a composite material.

Fairing 90 and fairing 94 are used to connect, respectively, starboard end 22 of the front wing 16 and starboard end 26 of the rear wing 18 to the starboard nacelle 12. Fairing 92 and fairing 96 are used to connect, respectively, port end 20 of the front wing 16 and port end 24 of rear wing 18 to the port nacelle 14. The fairings 90, 92, 94 and 96 help to provide a more hydrodynamically streamlined connection between the wings 16 and 18 and the nacelles 12 and 14. The fairings 90, 92, 94 and 96 are not required in all embodiments. For example, the ends 20, 22, 24, 26 could be secured directly into respective nacelles 12 and 14 using a fixing means such as a fastener and/or adhesives. In an embodiment, the wings 16 and 18 are integrally formed with the nacelles 12 and 14.

The front wing 16 has a starboard side 28 and port side 30. The starboard side 28 has a front starboard control flap 32 and the port side 30 has a front port control flap 34. The starboard control flap 32 and port control flap 34 are located on a trailing or rear edge of the front wing 16. In the embodiments shown in the Figures, the starboard side 28 and port side 30 are two separate sections joined together. However, in an embodiment, the starboard side 28 and port side 30 are integral with one another. The rear wing 18 has a rear starboard wing 35 and a rear port wing 36. A connector 48 connects the rear starboard wing 35 to the rear port wing 36. The rear starboard wing 35 has a rear starboard control flap 38 and the rear port wing 36 has a rear port control flap 40. The control flaps 38 and 40 are located on a trailing or rear edge of the rear wing 18. The connector 48 is not required in all embodiments. For example, the rear starboard wing 35 and rear port wing 36 may be integrally formed.

The rear starboard wing 35 and rear port wing 36 are each depicted as being straight and connect at a point at the connector 48. However, in an embodiment the rear starboard wing 35 and rear port wing 36 may be connected with a curved or polyhedral transition whereby the curve transition forms an apex of the rear wing 18 with each of the rear starboard wing 35 and rear port wing 36 being straight. Accordingly, the connector 48 is not required in all embodiments. Typically, the connector 48 is positioned at an apex of the rear wing 18. However, when the connector 48 is omitted, the apex of the rear wing 18 is defined by the upper most location of the rear wing 18.

The terms “front” and “rear” with respect the flaps 32, 43, 38 and 40 relate to an association with the front wing 16 and rear wing 18 and is not to be interpreted as specifying a location of the flaps on the fore edge or trailing edge of each wing 16 and 18.

In an embodiment, the nacelles 12 and 14 have a vertical thickness that is greater than a thickness of the wings 16 and 18. In an embodiment, a ratio of a vertical thickness of the nacelles 12/14 to a thickness of the wings 16/18 is at least 2:1. The ratio may be 2.5:1, 3:1, 3.5:1 4:1, 4.5:1, 5:1, or >5:1. This difference in thickness allows the nacelles 12 and 14 to act as wing caps. By acting as wing caps, nacelles 12 and 14 help to reduce generation of wing-tip vortices coming off the wings 16 or 18. Additionally, by acting as wing caps, the nacelles 12 and 14 eliminate the need for complex and fragile winglets or washed-out wingtips as a way to improve wing efficiency. Having the wings 16 and 18 be within an envelope of the nacelles 12 and 14 also helps to protect the wings 16 and 18 from damage, such as from debris and other underwater obstructions.

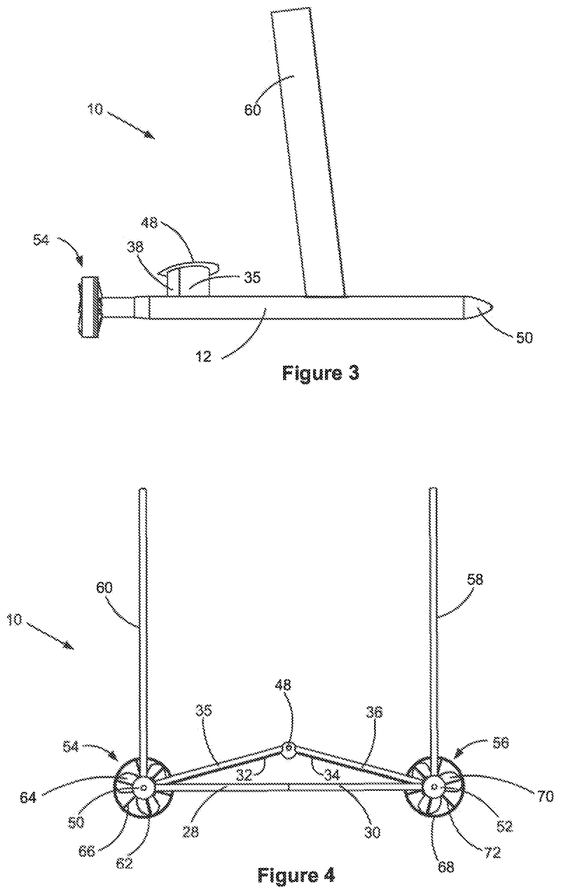

In the embodiments shown in FIG. 1 to FIG. 9, the front wing 16 is straight or linear and the rear wing 18 is anhedral. An anhedral angle is formed between planes of the rear starboard wing 35 and the rear port wing 36 of the rear wing 18. The anhedral angle of the rear wing 18 can help to increase roll and yaw control levers. The connector 48 is positioned at an apex of the rear wing 18. In an embodiment, the anhedral angle ranges from about 5° to about 45°. In an embodiment, the anhedral angle ranges from about 5° to about 40°. In an embodiment, the anhedral angle ranges from about 5° to about 35°. In an embodiment, the anhedral angle ranges from about 5° to about 30°. In an embodiment, the anhedral angle ranges from about 5° to about 25°. In an embodiment, the anhedral angle ranges from about 5° to about 20°. In an embodiment, the anhedral angle ranges from about 10° to about 20°. In an embodiment, the anhedral angle is greater than about 5°. In an embodiment, the anhedral angle is less than about 40°. In an embodiment, the anhedral angle is less than about 25°. As best shown in FIGS. 3 and 4, in an embodiment the apex of the rear wing 18 is positioned on a plane that is above a plane of the front wing 16.

The hydrofoil 10 has a mounting structure to mount the hydrofoil 10 to a watercraft. In the embodiments shown in the Figures, the mounting structure is in the form of masts 60 and 58. Starboard mast 60 extends from the starboard nacelle 12 and port mast 58 extends from port nacelle 14. Each mast 58 and 60 extends transversely away from the respective nacelle 14 and 12 in an aft or rear direction. In this way, the masts 58 and 60 are raked backwards. In an embodiment, the masts 58 and 60 are raked backwards by about 3° to about 9°. Masts that rake backwards can help to reduce or eliminate ventilation extending down the masts 58 and 60 to the wings 16 and 18. The combination of the nacelles 12 and 14 (e.g. support structure), masts 60 and 58 (e.g. mounting structure), and wings 16 and 18 forms a U-foil hydrofoil. As best seen in FIG. 7, mast 60 is hollow having an internal passage in the form of interior 91. Mast 58 can also be hollowing having an internal passage. In an embodiment, masts 58 and 60 have a low-drag profile. The masts 58 and 60 are depicted as being straight, but in an embodiment the masts 58 and/or 60 may be curved or have sections that are curved. For example, an upper segment of the mast may be straight, and a lower segment may have a curved transition into the connection point with the respective nacelle.

The hydrofoil 10 also has a starboard electric propulsor 54 and port electric propulsor 56. The starboard electric propulsor 54 is mounted to the starboard nacelle 12 and the port electric propulsor 56 is mounted to the port nacelle 14. Each propulsor 54 and 56 has a propeller 64 and a duct 62 surrounding the propeller 64. The duct 62 is connected to a housing of a motor 74 of the propulsor 54 using duct supports 66. The duct 62 helps to optimise the efficiency of the propeller 64 and protect personnel from the propeller 64.

The propulsors 54 and 56 can be electronically activated and controllable to provide a desired amount of thrust to move the hydrofoil 10 through the water. In an embodiment, a power of the propulsors 54 and 56 range from about 2 kW to about 50 kW. In an embodiment, a power of the propulsors 54 and 56 are at least 2 kW. In an embodiment, a power of the propulsors 54 and 56 are at most 50 kW. An advantage of electric propulsors is that they can generate reverse thrust without the need of a gearbox. Movement of water over the wings 16 and 18 generates lift that allows the hydrofoil 10 to lift a watercraft attached to the hydrofoil 10 out the water. In an embodiment, in use, the front wing 16 provides greater lift (i.e. >50%) than the rear wing 18.

An advantage of positioning the propulsors at the rear of the hydrofoil 10 is that turbulent water generated by the propeller 64 does not pass over the wings 16 and 18. An efficiency of a wing is typically decreased when turbulent water passes over the wing. However, in an embodiment, the propulsors 54 and 56 are located at a front or bow or the nacelles 12 and 14 (not shown). Having a motor of the propulsors 54 and 56 be mounted to the nacelles 12 and 14 means that the motors can be cooled by water contacting the housing of the motor 74 rather than having to rely on an active cooling system that requires pumps. In an embodiment, in use, the motors are constantly cooled by water. The in use of water that passes over a surface of the motor 74 as a passive cooling fluid rather than radiator fins exposed to air provides more efficient cooling of the motor 74. In an embodiment, a minimum diameter of the motor windings will determine the hydrodynamics and thus diameter of the nacelles 12 and 14.

As best shown in FIG. 7, a forward portion 97 of the motor 74 is housed within a rear portion 93 of the starboard nacelle 12. The rear portion 93 is provided with a tapered or ramped surface 95 that provides hydrodynamic transition from the starboard nacelle 12 to the propulsor 54. The ramped surface 95 is not required in all embodiments. As best shown in FIG. 6, in an embodiment, each propulsor 54 and 56 can include a skeg or fin 76 extending forward from the duct 62. The fin 76 is located on a bottom side of the duct 62. The fin 76 can be connected to a housing of the motor 74 and/or the starboard nacelle 12. A leading or front edge 79 of the fin 76 transitions to a bottom edge 77. The fin 76 helps to protect the duct 62 and/or propeller 64 from foreign objects such as rocks and debris in the water. For example, if a piece of debris hits the front edge 79, the debris can slide down the front edge 79, along the bottom edge 77, and past the duct 62.

Each of the control flaps 32, 34, 38 and 40 can rotate about an axis of rotation independently of one another. The axis of rotation extends along a span of the respective wing 16 or 18. The front control flaps 32 and 34 are both rotatable about a common rotation axis. The control flaps 32, 34, 38 and 40 are individually controllable by an electronically controlled actuator. In the embodiments shown in the Figures, the electronically controlled actuator is in the form of a servo motor. In an embodiment, a torque of the servo motor ranges from about 50 kg/cm up to 250 kg/cm. With best reference to FIGS. 7 and 8 and the starboard nacelle 12, servo motor 80 is located in an interior 98 of the starboard nacelle 12 and is connected to the front starboard flap 32. Servo motor 82 is located in the interior 98 of the starboard nacelle 12 and is connected to rear starboard flap 38. Each servo motor 80 and 82 has a shaft in the form of a spline 86 that connects to a horn 84. The shaft may optionally use a key or pin to attach to the flaps 32 and 34. In FIG. 8, the horn 84 is connected directly to the front starboard flap 32 such that the axis of rotation of the spline 86 and the axis of rotation of the front starboard flap 32 are aligned.

The connection between the servo motor 80 and the front starboard flap 32 is direct without any linkages or cams and can be referred to as a direct control drive. A direct control drive helps to minimise or eliminate any slop or play and may improve the reliability and maintenance costs of the hydrofoil 10. In an embodiment, the servo motors are connected to a respective flap by a linkage or cam mechanism. Servo motor 82 is connected to the rear starboard flap 38 in the same way as servo motor 80 is connected to the front starboard flap 32. Port flaps 34 and 40 are connected to respective servos motor that are located in the port nacelle 14 in the same way as servo motor 80 is connected to the front starboard flap 32. In an embodiment, servo motor control wires pass down the interior 91 of the mast 60, and similarly for mast 58, into the interior 98 and connect to either servo motor 80 or servo 8 motor 2 (not shown in the Figures for clarity purposes only). The servo motors 80 and 82 are electrically connected to a control system.

Propulsor 54 is electrically connected to a starboard speed controller and propulsor 56 is electrically connected to a port speed controller. The starboard and port speed controllers may be mounted on a watercraft associated with the hydrofoil 10. With reference to FIG. 7 and using the starboard nacelle 12 and mast 60 as an example, when the speed controllers are mounted on the watercraft, three phased AC wires connecting the propulsor 54 to the speed controller pass from the watercraft, down an interior 91 of mast 60, and through an interior 98 of the nacelle 12. In an embodiment, a speed controller 88 is mounted in the interior 98 of the nacelle 12. When the speed controller 88 is mounted in the interior 98 of the nacelle 12, two wires connecting the speed controller 88 to a DC power supply pass from the interior 98 and up the interior 91 of the mast 60. The wires associated with the speed controller and propulsors are not shown in the Figures for clarity purposes only.

An advantage of housing the speed controller 88 in the nacelle 12 is that heat generated by the speed controller can be dissipated by water passing over the nacelle 12. The use of water rather than air as a cooling fluid helps to provide more efficient speed controller cooling. Another advantage of housing the speed controller 88 in the nacelle 12 is that only two wires (the DC power supply wires) need to pass from the speed controller 88 up the mast 60 to a power supply, whereas if the speed controller 88 is mounted on the watercraft three AC phase cables need to run down the mast 60. Reducing the number of wires of the propulsor 54 and 56 that need to pass through the mast helps to increase their thickness and corresponding current delivering capability for more power. The port nacelle 14 can equally house a speed controller 88 similar to the starboard nacelle 12. Housing components that require cooling in the nacelles 12 and 14 eliminates the need to provide a water-cooling system that pumps water from the hydrofoil up to the watercraft, which can be problematic for watercraft fitted with hydrofoils.

The starboard nacelle 12 and port nacelle 14 are each provided with a nose cone which in the Figures is in the form of a cap. Starboard cap 50 is positioned at a front or bow of the starboard nacelle 12 and port cap 52 is positioned at a front or bow of the port nacelle 14. The caps 50 and 52 may act as dampeners or crumple zones in a collision with debris. In an embodiment, the caps 50 and 52 are each replaceable. The caps 50 and 52 may be fitted with one or more sensors, such as a camera, a temperature sensor, or transducer(s) and receiver(s). The sensors may provide information to a control system.

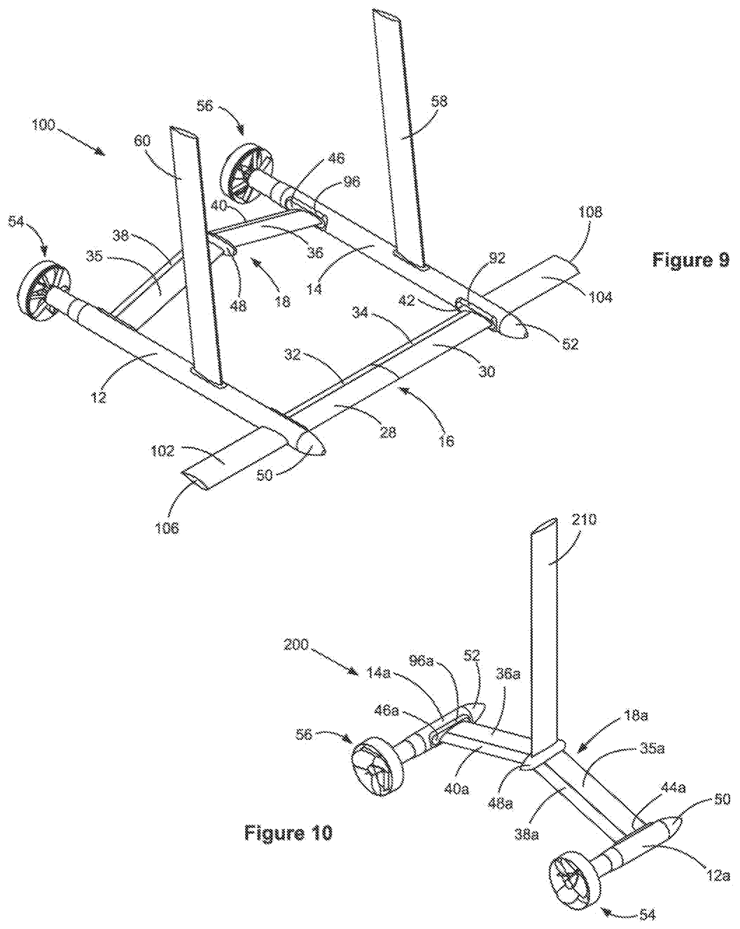

FIG. 9 shows another embodiment of a hydrofoil. Hydrofoil 100 is the same as hydrofoil 10, except that hydrofoil 100 has port and starboard auxiliary front wing components. In FIG. 9, the auxiliary front wing components are in the form of starboard front side wing 102 and port front side wing 104. The front side wings 102 and 104 extend laterally outwards from the respective starboard nacelles 12 and port nacelle 14. The front side wings 102 and 104 share a common longitudinal position with the front wing 16. For example, a longitudinal direction defined by the leading edge of the front wing 16 may intersect with a longitudinal direction of each of the leading edges of the front side wings 102 and 108. These longitudinal directions are located at the same position on the nacelles 12 and 14. However, in an embodiment, a longitudinal position of the front side wings 102 and 104 is offset relative a longitudinal position of the front wing 16. For example, the front side wings 102 and 104 may be positioned foreward or rearward of front wing 16. The front side wings 102 and 104 form part of the front wing 16 and can help to increase the lift generated at a front or bow of the hydrofoil 100. Ends 106 and 108 of the front side wings 102 and 104 are depicted in FIG. 9 without end caps or winglets or washed-out wing tips. In an embodiment, the ends of the front side wings 102 and 104 have end caps or winglets or washed-out wing tips that help to reduce turbulent flow from the front side wings 102 and 104.

The front side wings 102 and 104 may be used when a take-off weight capacity of the hydrofoil 10 needs to increase. For example, hydrofoil 10 may have a take-off weight capacity of 200 kg, but the addition of front side wings 102 and 104 can increase the take-off weight capacity above 200 kg. The amount by which the take-off capacity is increased by the addition of front side wings 102 and 104 is determined by the dimensions of front side wings 102 and 104, including the chord length, maximum wing (foil) thickness, leading edge radius, camber, and angle of attack.

FIG. 10 shows another embodiment of a hydrofoil. Hydrofoil 200 is similar to hydrofoils 10 and 100, except that the front wing 16 has been omitted. Hydrofoil 200 has a single wing 18a having an anhedral angle the same as rear wing 18 from hydrofoil 10 and 100. Hydrofoil 200 has a starboard support structure in the form of starboard tube or nacelle 12a, and a port support structure in the form of port tube or nacelle 14a. Each nacelle 12a and 14a extends longitudinally in a fore-aft direction. The nacelles 12a and 14a are parallel to one another. As hydrofoil 200 does not have a front wing, the nacelles 12a and 14a are shorter compared to nacelles 12 and 14 from hydrofoil 10 and 100.

The hydrofoil 200 has a starboard electric propulsor 54 connected to nacelle 12a and port electric propulsor 56 connected to nacelle 14a. The anhedral wing 18a has a starboard side or end 44a that is connected to the starboard nacelle 12a and a port side or end 46a that is connected to the port nacelle 14a. In an embodiment the rear wing 18a is formed from extruded aluminium. In an embodiment, the rear wing 18a is formed from a composite material. The wing 18a has a rear starboard wing 35a and a rear port wing 36a. A connector 48a connects the rear starboard wing 35a to the rear port wing 36a. The rear starboard wing 35a has a starboard control flap 38a and the rear port wing 36a has a port control flap 40a. The control flaps 38a and 40a are located on a trailing or rear edge of the rear wing 18a. When hydrofoil 200 is connected to a watercraft, a separate forward foil, such as a flat foil, may be used to provide a majority of the lift for the watercraft, with control authority being provided by the hydrofoil 200. The front foil may be connected to the watercraft using one or more masts as a support structure.

The embodiments shown in the Figures depict the front wing 16 as being connected to the nacelles 12 and 14 along a plane that extends through an axis of the nacelles 12 and 14. However, in an embodiment, the front wing 16 is connected to the nacelles 12 and 14 towards or at a top side or bottom side of the nacelles 12 and 14. Similarly, the rear wing 18 is depicted in the Figures as being connected to the nacelles 12/12a and 14/14a along a plane that extends through an axis of the nacelles 12 and 14. However, in an embodiment, the rear wing 18 is connected to the nacelles 12/12a and 14/14a towards or at a top side or bottom side of the nacelles 12/12a and 14/14a.

Hydrofoil 10, 100 or 200 can be fitted to a watercraft using the mounting structure. When the mounting structure is in the form of masts 58 and 60, the hydrofoil 10 is mounted to the watercraft using the masts 58 and 60. The masts 58 and 60 may be positioned inboard or outboard of the watercraft. When the mounting structure is in the form of mast 210, the hydrofoil 200 is mounted to the watercraft using the mast 210. Optionally, in hydrofoil 200, each nacelle 12a and 14a is provided with its own mounting structure e.g. mast. Hydrofoil 10, 100 or 200 can have one or more masts as the support structure to connect the hydrofoil to the watercraft.

In use of the hydrofoil 10, 100 or 200, the starboard and/or port speed controller (e.g. 88) is activated to provide power to the electric motors (e.g. 74) to rotate the propellers (e.g. 64) to generate thrust. Differential thrust generated by the propulsors causes a yaw movement. In this way, differential thrust of the propulsors provides yaw control authority. Generation of forward thrust causes the hydrofoil 10 or 100 to move forward which results in water flowing over at least the front wing 16 (or the rear wing 18a for hydrofoil 200) in a direction from the leading edge to the trailing edge to cause at least the front wing 16 to generate lift. The amount of lift generated by the front wing 16 is dependent upon a speed that the front wing 16 travels through the water and a profile of the front wing 16. This wing movement is relative water and not a speed over the ground.

The amount of lift generated by the front wing 16 is also dependent upon a pitch angle of the front starboard flap 32 and rear port flap 34. A high pitch angle (or moment) is formed when the front starboard flap 32 and front port flap 34 are angled maximally downwards. The maximally downwards angle is dependent upon a profile of the front wing 16. An increase in pitch angle causes an increase in lift at the expense of increased drag. The servos (e.g. 80) connected to the front starboard flap 32 and front port flap 34 can be actuated by a control system to adjust a pitch angle of the front starboard flap 32 and front port flap 34 to cause maximal lift at the front wing 16 for a given speed. Throughout this disclosure, the term “speed” or “flow” is in reference to the speed or flow at which the hydrofoil travels through the water. In an embodiment, the front wing 16 generates more than 50% of the lift of the hydrofoil. When sufficient lift is generated, a watercraft attached to the hydrofoil 10 or 100 is lifted out of the water to be in a lifted state. Once in a lifted state, actuation of the servos to control the front starboard flap 32 and front port flap 34 acts to control the amount of lift generated at the front wing 16 thereby controlling an altitude of the watercraft.

A pitch angle of the rear starboard flap 38 and rear port flap 40 on the rear wing 18 can also be individually controlled by actuating respective servos to control the amount of lift generated by the rear wing 18 and similarly wing 18a. A high pitch angle is formed when the rear starboard flap 38 or 38a and rear port flap 40 or 40a are angled maximally downwards. The maximally downwards angle is dependent upon a profile of the rear wing 18. Once in a lifted state, actuation of the servos to control the rear starboard flap 38 and rear port flap 40 acts to control the amount of lift generated at the rear wing 18 thereby helping to control an altitude of the watercraft. For hydrofoil 200, the anhedral wing 18a provides all the lift to lift the watercraft out of the water.

For hydrofoil 10 and 100, the front starboard flap 32 and front port flap 34 can each be adjusted independently from the rear starboard flap 38 and rear port flap 40 to generate differential lift. For example, increasing a pitch angle of the front starboard flaps 32 and port flap 34 compared to a pitch angle of the rear starboard flap 38 and rear port flap 40 generates greater lift at the front wing 16 compared to the rear wing 18. Having a greater lift at the front wing 16 causes a front of the hydrofoil 10 or 100 to lift up, thereby increasing a pitch of the watercraft attached to the hydrofoil 10 or 100. Conversely, adjusting the flaps 32, 34, and/or 38 and 40 so that the front wing 16 generates less lift than the rear wing 18 causes a front of the hydrofoil 10 or 100 to drop, thereby decreasing a pitch of the hydrofoil. Generation of differential lift may be used to control a pitch angle of the hydrofoil 10 or 100. In an embodiment, the transition to the lifted state may be facilitated by providing differential lift to provide a positive hydrofoil pitch.

In the lifted state, when a speed of the hydrofoil increases by increasing a thrust generated from the propulsors 54 and/or 56, the amount of lift generated by at least the front wing 16 increases if a pitch angle of the front starboard flap 32 and front port flap 34 remains constant. Accordingly, in an embodiment, when a thrust generated by the propulsors 54 and 56 increases, a pitch angle of the front starboard flap 32 and front port flap 34 is reduced to reduce the amount of lift generated by the front wing 16. This adjustment of pitch angle is sometimes referred to as feathering out of the foil or wing.

The front starboard flaps 32 and port flap 34 on the front wing 16 can be adjusted independently of one another to control a roll authority. Similarly, the rear starboard flap 38 and rear port flap 40 on the rear wing 18 can be adjusted independently of one another to control a roll authority. A roll authority may also be provided when the either front and rear starboard flaps 32 and 38 or the front and rear starboard and port flaps 34 and 40 are adjusted in unison. For example, if the front and rear starboard flaps 32 and 38 are actuated upwards and the front and rear port flaps 34 and 40 are actuated downwards, the watercraft will roll to starboard.

Roll authority can also be provided by differentially actuating the rear starboard flap 38 and the rear port flap 40. Yaw authority can also be provided by differentially actuating the rear starboard flap 38 and the rear port flap 40. Roll and yaw may be simultaneously controlled by differentially actuating the rear starboard flap 38 and rear port flap 40. An advantage of having the rear wing 18 be anhedral is that it provides more roll and yaw authority to the hydrofoil 10 compared to the front wing 16. The anhedral angle of the rear wing 18 provides greater roll and yaw authority by increasing a lever force between a lift of the rear wing 18 and a centre of gravity of the watercraft. Generally, the front wing 16 provides greater pitch authority and the rear wing 18 provides greater roll and yaw authority. However, the front wing 16 can contribute to roll authority and the rear wing 18 can contribute to pitch authority.

The front flaps 32 and 34 could be considered as being elevons because the front flaps 32 and 34 act as combined elevator and ailerons. The rear starboard flap 38 and rear port flap 40 could be considered as being ruddervators or tailerons because they act as combined tail rudder, ailerons and elevators.

A summary of how relative movement of the control flaps 32, 34, 38 and 40 can be moved to provide roll, pitch, and yaw authority or control either in isolation or combination is provided in Table 1. In an embodiment, the flaps 32, 34, 38 and 40 can be actuated using the respective servos to simultaneously control two or more of lift, roll, pitch, and yaw. For example, turning the watercraft whilst adjusting an altitude may involve simultaneously adjusting pitch and yaw and optionally roll.

TABLE 1
Relative flap movement and the resulting
movement of the watercraft.

| Relative flap movement | | | | |
|---|---|---|---|---|
| Front | | Rear | | |
| starboard | Front port | starboard | Rear port | Hydrofoil |
| flap 32 | flap 34 | flap 38 | flap 40 | Movement |
| Upwards | Upwards | None or | None or | Pitch down |
| | | downwards | downwards | |
| Downwards | Downwards | None or | None or | Pitch up |
| | | upwards | upwards | Starboard |
| Upwards | Downwards | None or | None or | roll |
| | | upwards | downwards | |
| Downwards | Upwards | None or | None or | Port roll |
| | | downwards | downwards | |
| None | None | Upwards or | Downwards | Yaw and |
| | | downwards | or upwards | roll |
| Downwards | Downwards | Downwards | Downwards | Lift |

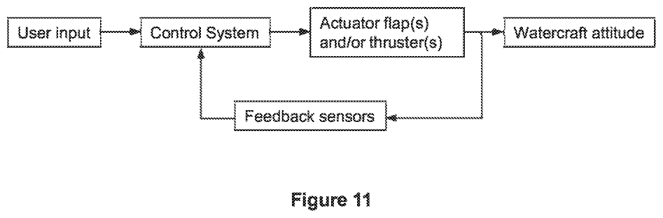

An exemplary control flow chart is shown in FIG. 11. A user input, such as from a joystick, tablet or remote control is fed into a control system. The control system can then actuate or control the flap(s) and/or propulsors. The control system may include a stability control algorithm. Feedback sensors, such as gyroscopic sensors, accelerometers, ultrasonic distance sensors, magnetic field sensors, (D)GPS and altitude sensors, may be used by the control system to monitor any changes to the watercraft attitude. The feedback sensors are exemplary only and not exclusive.

In the claims which follow and in the preceding description of the disclosure, except where context requires otherwise due to expressed language or necessary implications, the word “comprise” or variants such as “comprises” or “comprising” is used in an inclusive sense i.e. to specify the presence of the state features but not to preclude the presence or addition of further features in various embodiments.

1. A hydrofoil comprising:
a starboard support structure and a port support structure, each structure being hollow and extending longitudinally in a fore-aft direction and being parallel to one another;
an anhedral wing having ends connected to the starboard support structure and the port support structure; and
a starboard electric propulsor mounted to the starboard support structure and a port electric propulsor mounted to the port support structure.

2. A hydrofoil as claimed in claim 1, wherein the anhedral wing has at a trailing edge a starboard control flap and a port control flap, each control flap being rotatable about a rotation axis.

3. A hydrofoil as claimed in claim 2, further comprising an electronically controlled actuator connected to each control flap, wherein each of the electronically controlled actuators are located in the starboard support structure or the port support structure.

4. A hydrofoil as claimed in claim 3, wherein each electronically controlled actuator has a shaft that is rotatable about an actuator rotation axis, and wherein each electronically controlled actuator is directly connected to a respective control flap such that the rotation axis of the control flap and the rotation axis of the shaft are aligned.

5. A hydrofoil as claimed in claim 1, wherein an angle of the anhedral wing ranges from about 5° to about 25°.

6. A hydrofoil as claimed in claim 5, wherein the angle of the anhedral wing ranges from about 10° to about 20°.

7. A hydrofoil as claimed in claim 1, wherein the starboard support structure and the port support structure are each dimensioned relative the anhedral wing to act as wing caps.

8. A hydrofoil comprising:
a starboard support structure and a port support structure, each support structure being hollow and extending longitudinally in a fore-aft direction and being parallel to one another;
a front wing having ends connected to the starboard support structure and the port support structure;
a rear anhedral wing having ends connected to the starboard support structure and the port support structure; and
a starboard electric propulsor mounted to the starboard support structure and a port electric propulsor mounted to the port support structure.

9. A hydrofoil as claimed in claim 8, wherein the front wing and rear wing each have at a trailing edge a starboard control flap and a port control flap, each control flap being rotatable about a rotation axis.

10. A hydrofoil as claimed in claim 8, further comprising an electronically controlled actuator connected to each control flap, each of the electronically controlled actuators being located in the starboard support structure or the port support structure.

11. A hydrofoil as claimed in claim 10, wherein each electronically controlled actuator has a shaft that is rotatable about an actuator rotation axis, and wherein each electronically controlled actuator is directly connected to a respective control flap such that the rotation axis of the control flap and the rotation axis of the shaft is aligned.

12. A hydrofoil as claimed in claim 8, wherein the rear anhedral wing has a starboard portion and a port portion.

13. A hydrofoil as claimed in claim 8, wherein an apex of the rear anhedral wing is located on a plane that is above a plane of the front wing.

14. A hydrofoil as claimed in claim 8, wherein an angle of the rear anhedral wing ranges from about 5° to about 25°.

15. A hydrofoil as claimed in claim 14, wherein the angle of the rear anhedral wing ranges from about 10° to about 20°.

16. A hydrofoil as claimed in claim 8, further comprising a starboard auxiliary front hydrofoil wing extending laterally out from the starboard support structure and a port auxiliary front hydrofoil wing extending laterally from the port support structure.

17. A hydrofoil as claimed in claim 16, wherein the starboard auxiliary front hydrofoil wing and the port auxiliary front hydrofoil wing share a common longitudinal position with the front wing.

18. A hydrofoil as claimed in claim 8, wherein, in use, the front wing provides greater lift than the rear anhedral wing.

19. A hydrofoil as claimed in claim 8, wherein support structure and the port support structure are each dimensioned relative the front wing and rear wing to act as wing caps.

20. A hydrofoil as claimed in claim 1, further comprising a starboard speed controller located in the starboard support structure and a port speed controller located in the port support structure, wherein the starboard speed controller is in electrical communication with the starboard electric propulsor and the port speed controller is in electrical communication with the port electric propulsor.

21. A hydrofoil as claimed in claim 1, further comprising a mounting structure for mounting the hydrofoil to a watercraft.

22. A hydrofoil as claimed in claim 8, further comprising a mounting structure for mounting the hydrofoil to a watercraft and wherein the mounting structure includes a starboard mast extending transversely from the starboard support structure and a port mast extending transversely from the port support structure.

23. A hydrofoil as claimed in claim 22, wherein the starboard mast and the port mast each extend transversely in a direction towards an aft of the starboard support structure and the port support structure.

24. A hydrofoil as claimed in claim 8, wherein the starboard electric propulsor is mounted at a rear of the starboard support structure and the port electric propulsor is mounted at a rear of the port support structure.

25. A hydrofoil as claimed in claim 8, wherein at least a portion of the starboard electric propulsor is mounted within the starboard support structure and at least a portion of the port electric propulsor is mounted within the port support structure.

26. A hydrofoil as claimed in claim 8, wherein each propulsor is provided with a duct that surrounds a propeller.

27. A hydrofoil as claimed in claim 26, further comprising a fin on a bottom side of the duct that extends from the duct in a fore direction.

28. A hydrofoil as claimed in claim 8, wherein each of the starboard support structure and the port support structure is provided with a nose cone.

29. A hydrofoil as claimed in claim 28, wherein the nose cone is fitted with one or more sensors.

30. (canceled)

31. (canceled)

32. A method of operating a hydrofoil connected to a watercraft, the hydrofoil comprising: a front wing having a front starboard control flap and a front port control flap; a rear anhedral wing having a rear starboard control flap and a rear port control flap; a starboard electric propulsor and a port electric propulsor, the method comprising:
activating the starboard electric propulsor and/or the port electric propulsor to generate a flow of water over the front wing and the rear anhedral wing; and
actuating the front starboard control flap and/or the front port control flap from the front wing to generate lift.

33. A method as claimed in claim 32, further comprising actuating the front starboard control flap and the front port control flap on the front wing to control lift and altitude from the front wing.

34. A method as claimed in claim 32, further comprising actuating the rear starboard control flap and the rear port control flap on the rear anhedral wing to control lift and altitude from the rear anhedral wing.

35. A method as claimed in claim 32, further comprising adjusting the front starboard control flap and the front port control flap on the front wing differentially to the rear starboard control flap and rear port control flap on the rear anhedral wing to control a pitch of the watercraft.

36. A method as claimed in claim 32, further comprising actuating the front starboard control flap on the front and the rear starboard control flap on the rear anhedral wing differently to the front port control flap on the front and the rear port control flap on the rear anhedral wing to control a roll of the watercraft.

37. A method as claimed claim 32, further comprising differentially actuating the rear starboard control flap and the rear port control flap on the rear anhedral wing to control a yaw and/or roll of the watercraft.

38. A method as claimed in claim 32, further comprising applying a differential thrust to the starboard electric propulsor and the port electric propulsor to control a yaw of the watercraft.

39. A method as claimed in claim 32, further comprising:
controlling the starboard electric propulsor and the port electric propulsor to increase the flow of water over the front wing and the rear anhedral wing, and
actuating the front starboard control flap, the front port control flap, the rear starboard control flap, and/or the rear port control flap as a function of watercraft speed to adjust lift generated at the front wing and/or the rear anhedral wing.

40. (canceled)

41. (canceled)

42. A hydrofoil as claimed in claim 8, further comprising a starboard speed controller located in the starboard support structure and a port speed controller located in the port support structure, wherein the starboard speed controller is in electrical communication with the starboard electric propulsor and the port speed controller is in electrical communication with the port electric propulsor.

43. A hydrofoil as claimed in claim 8, further comprising a mounting structure for mounting the hydrofoil to a watercraft.
